(19) United States
(12) Patent Application Publication
(10) Pub. No.: US 2021/0243953 A1
(43) Pub. Date: Aug. 12, 2021

(54) SPREADER ATTACHMENT FOR A MOWER

(71) Applicant: 1636457 Alberta Ltd., Grande Prairie (CA)

(72) Inventor: Russell R. NIEMI, Grande Prairie (CA)

(21) Appl. No.: 17/156,751

(22) Filed: Jan. 25, 2021

(30) Foreign Application Priority Data
Feb. 7, 2020 (CA) 3071705

(51) Int. Cl. A01D 43/14; B05B 13/00; A01D 34/67; A01C 17/00; A01C 23/04

(52) U.S. Cl. CPC A01D 43/14; B05B 13/005; A01D 34/67; A01D 2101/00; A01C 17/005; A01C 23/04; A01C 17/001

(57) ABSTRACT

A dispenser assembly for a mower that selectively dispenses liquid or particulates onto the ground is provided. The dispenser has a hopper with an inner receptacle, an attachment to the mower, and a particulate outlet at the bottom of the receptacle. The dispenser also has a tank that removably nests within the receptacle and a particulate distributor in communication with the outlet. The particulate distributor has an agitator within the receptacle near the outlet, the agitator directing particulates toward the outlet, and a spreader that distributes the particulates from the outlet onto the ground surface. The dispenser also has a fluid distributor carried by the mower that has a fluid passage releasably connected to the fluid outlet of the tank and a fluid manifold connected to the fluid passage. Fluid is pumped through the fluid passage to a fluid manifold, which distributes the fluid onto the ground.

### TECHNICAL FIELD

This relates to distributing liquid or granular materials over an area of a landscape, and in particular, to a spreader attachment that can be used in combination with a lawn mower.

### BACKGROUND

It is often required to spread a granular or liquid material such as fertilizer, pesticide, or grass seed, evenly over a large area of a landscape, such as a lawn or sports field. U.S. Pat. No. 4,955,538 (Laube et al.) entitled APPLICATOR AND METHOD FOR THE DELIVERY OF GRANULAR AND LIQUID PRODUCTS TO TURF AREAS teaches an applicator for the delivery of these materials.

### SUMMARY

According to an aspect, there is provided a dispenser assembly for a mower that selectively dispensing liquid or particulates onto a ground surface. The dispenser assembly comprises a hopper having an inner wall that defines a receptacle, and a particulate outlet at a bottom of the receptacle. The hopper is carried by the mower. There is a tank sized to removably nest within the receptacle, the tank having a sidewall and a fluid outlet. A particulate distributor is in communication with the particulate outlet, the particulate distributor being adapted to distribute particulates through the particulate outlet onto the ground surface. A fluid manifold is carried by the mower that is releasably connectable to the fluid outlet of the tank by a fluid passage to deliver fluid from the tank to the fluid manifold.

According to further aspects, the dispenser assembly may comprise one or more of the following aspects, alone or in combination: the particulate distributor may comprise a motor that drives an agitator and a spreader, the agitator may be disposed within the receptacle adjacent to the particulate outlet, and the spreader may be disposed below the particulate outlet; a bottom of the hopper may comprise a raised profile that supports the tank above the agitator; the tank may have a profiled bottom surface that engages the receptacle to support the tank above the agitator; the hopper may comprise a releasable attachment that is configured to attach to a push bar of the mower; the fluid manifold ma comprise a spreader bar; the spreader bar may be attachable to a push bar of the mower such that, in operation, the spreader bar is suspended behind the mower in proximity to the ground surface; the spreader may comprise an opening in the outer wall of the hopper, the opening may be shaped to direct the particulates in a distribution pattern; the connection between the fluid passage and the fluid outlet of the tank may comprise a quick connect fluid connection; and the particulate outlet of the hopper may have an adjustable area.

According to an aspect, there is provided a method of selectively dispensing liquid or particulates onto a ground surface while operating a mower. The method comprises the steps of, providing a dispenser assembly as described above; attaching the dispenser assembly to the mower; selecting liquid or particulates to be dispensed onto the ground surface; when particulates are selected, removing the tank, filling the receptacle with the particulates, and distributing the particulates from the outlet onto the ground surface using the particulate distributor; and when the liquid material is selected, inserting the tank into the hopper, filling the tank with liquid, connecting the fluid outlet of the tank to the fluid passage of the fluid distributor, and distributing fluid onto the ground surface by flowing the fluid through the fluid manifold via the fluid passage.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a mower with an attached dispenser.

FIG. 2 is a front elevation view of a fluid tank and fluid distributor.

FIG. 3 is a front elevation view in section of a fluid tank nested within a hopper.

FIG. 4 is a front elevation view in section of a hopper.

FIG. 5 is a top plan view of a hopper.

FIG. 6 is a side elevation view of a hopper.

FIG. 7 is a front elevation view of a hopper connecting to a push bar.

FIG. 8 is a front elevation view in section of a hopper filled with particulate.

FIG. 9 is a front elevation view in section of a fluid tank filled with fluid and nested within a hopper.

### DETAILED DESCRIPTION

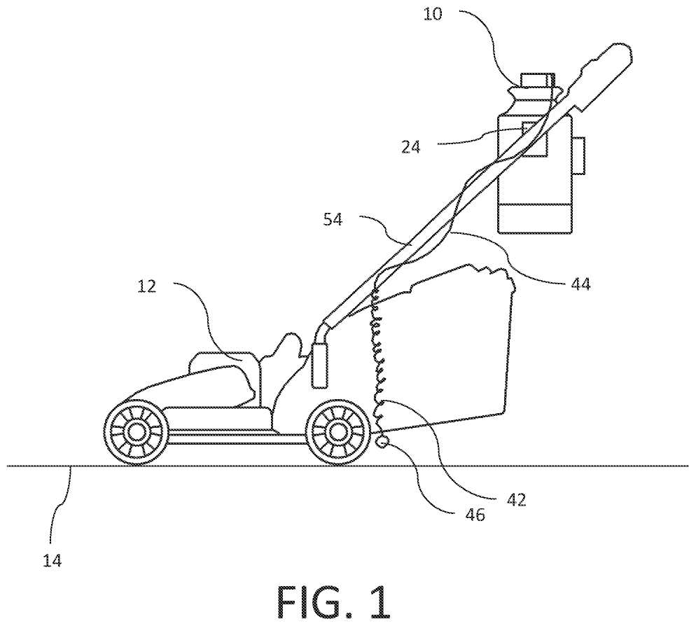

A dispenser assembly generally identified by reference numeral 10, will now be described with reference to FIGS. 1 through 9.

Referring to FIG. 1, dispenser assembly 10 may be attached to a lawnmower 12. As will be discussed below in more detail, dispenser assembly 10 is designed to selectively carry and dispense liquid or particulates onto a ground surface 14 using lawnmower 12 as the carrier. As will be understood, dispenser lawnmower 12 may be any of a variety of typical walk-behind mowers designed for residential or commercial applications. Lawnmower 12 has a push bar 54 that pushes the cutting portion of mower 12. Mower 12 may be either self-propelled or pushed manually, and may be manual, gas-powered, electric, etc. It will be understood by those skilled in the art that variations of lawnmower 12 are possible that will not affect the operation of dispenser assembly 10.

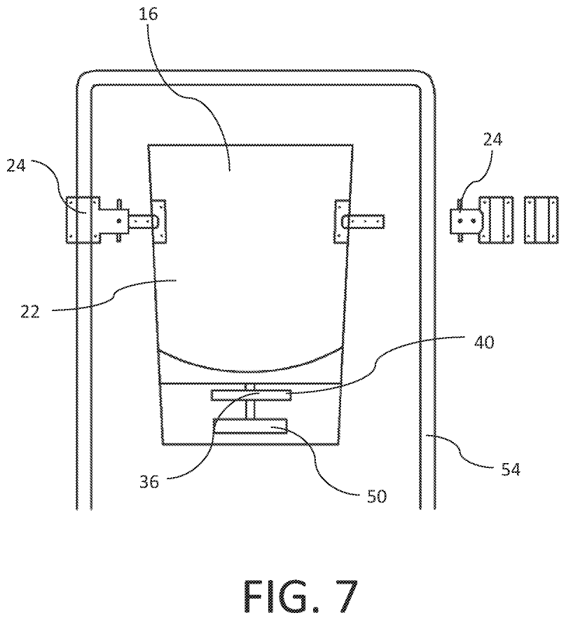

Referring to FIG. 4, dispenser assembly 10 has a hopper 16 with an inner wall 18 that defines a receptacle 20, and an outer wall 22 that comprises an attachment 24 that is designed to attach to mower 12. An example of an attachment 24 is shown in FIG. 7, where a two-part attachment is used to clamp around push bar 54, while suspending hopper 16 between the sides of push bar 54. Other designs for attachment 24 may also be used. If assembly 10 is installed as an aftermarket product, attachment 24 may be designed to attach to push bar 54. As many push bars 54 have a common size or at the very least are designed with a size of a typical range, it may be possible to design a universal attachment that attaches to most handles of walk behind mowers. Alternatively, assembly 10 may be manufactured with different sizes or styles of attachment to attach to a wider range of push bars 54, custom manufactured for a particular design of mower 12, or integrated into push bar 54 when mower 12 is manufactured. It will also be understood that attachment 24 may be configured to attach to other portions of the mower, such as being attached to the top surface of the mower or being supported behind the collection bag.

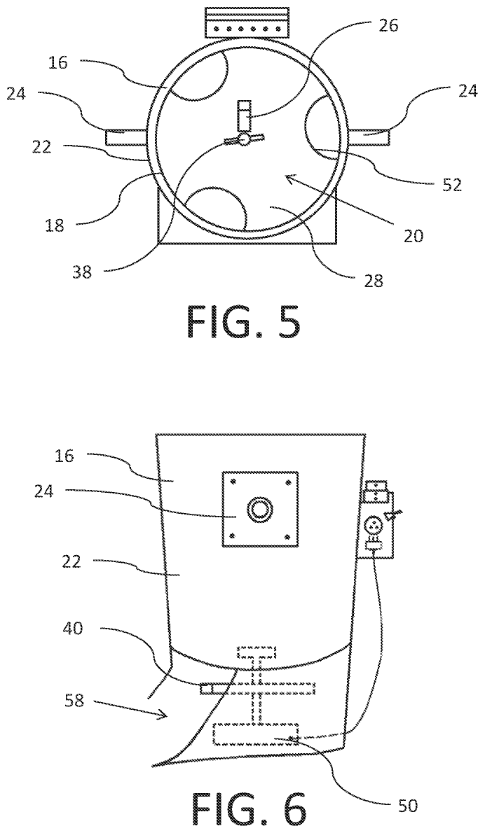

Referring to FIGS. 4 and 5, dispenser assembly 10 has a particulate outlet 26 at a bottom 28 of receptacle 20 with a particulate distributor 36 in communication with particulate outlet 26. Particle distributor 36 may be gravity fed by particulates carried within receptacle 20, or may have an agitator 38 within receptacle 20 and adjacent to particulate outlet 26 that directs particulates toward particulate outlet 26. As shown in FIG. 5, particulate outlet 26 may have an adjustable area to allow for different flow rates of particulates to pass through particulate outlet 26. Particulate distributor 36 may also have a spreader 40 that is designed to more evenly or predictably distribute the particulates from particulate outlet 26 onto ground surface 14. Particulate distributor 36 may be provided with a motor 50 that drives agitator 38 and spreader 40. Particulate distributor 36 may also be manually powered or may be driven by the motion of mower 12 or powered from mower 12. Referring to FIG. 6, spreader 40 may have an opening 58 in outer wall 22 of hopper 16 that is shaped to direct the particulates in a distribution pattern.

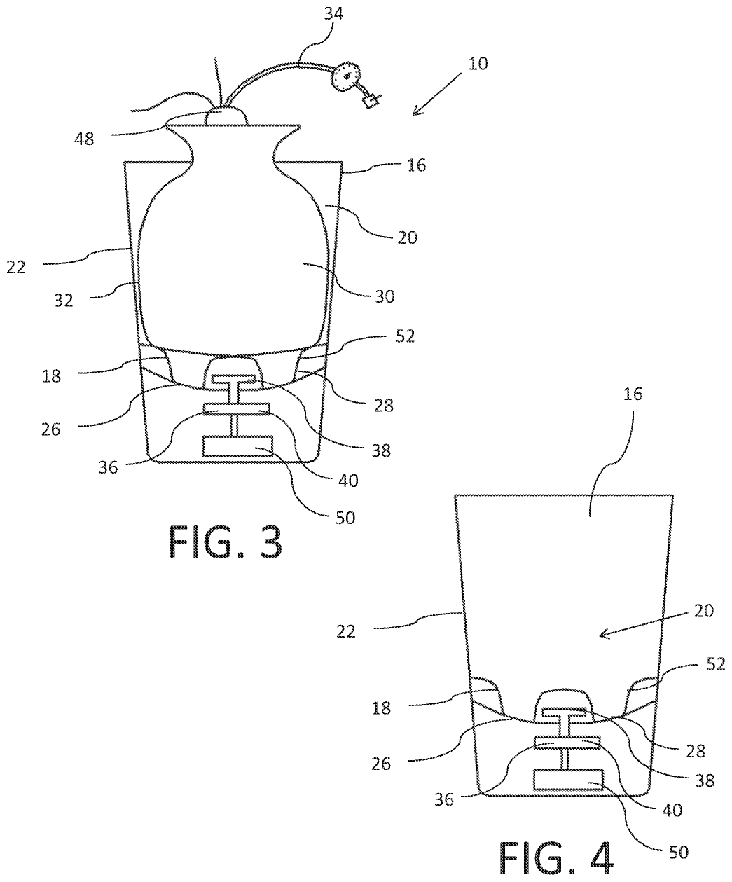

Referring to FIG. 3, a tank 30 that has a sidewall 32 and a fluid outlet 34 is provided that sized to fit within receptacle 20. Tank 30 is removably inserted into receptacle 20, and is preferably securely held when inserted, either using a friction fit, clamp, handle, or other type of suitable design, to prevent accidental removal during operation.

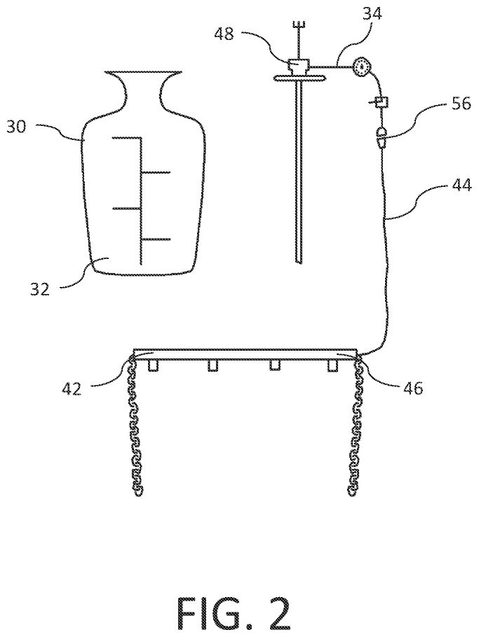

Referring to FIG. 1, a fluid distributor 42 is carried by mower 12. Referring to FIG. 2, fluid distributor 42 has a fluid passage 44 that releasably connects to fluid outlet 34 of tank 30 and a fluid manifold 46 connected to fluid passage 44. As shown, the connection between fluid passage 44 and fluid outlet 34 may be a quick connect fluid connection 56, although other forms of connections may be used. A continuous fluid passage 44 may extend from an opening that serves as fluid outlet 34 in tank 30 to fluid manifold 46. When tank 30 is installed, fluid manifold 46 receives fluid from tank 30 and distributes fluid onto the ground surface 14. To provide sufficient pressure, a pump 48 may be used to pump fluid through fluid passage 44. Other methods of creating pressure may be used, such as a hand pump that creates air pressure within tank 30, or through the use of gravity based on the height of tank 30 above fluid manifold 46. As shown, fluid manifold 46 is a spreader bar, however, it will be understood that fluid manifold 46 may take other forms as is known in the art. In one example, fluid manifold 46 may be a spreader bar that is attached to push bar 54 of mower 12 such that it hands below push bar 54 and trails mower 12 in proximity to ground surface 14, as shown in FIG. 1. It will be understood that spreader bar 46 may also be placed in other locations where it does not impede the operation of mower 12. As shown in FIG. 3, the bottom portion of hopper 16 may have a raised profile 52 that supports tank 30 above agitator 38. The raised profile 52 may be formed as part of inner wall 18. Tank 30 may also be provided with a profiled bottom surface (not shown) that engages receptacle 20 to support tank 30 above agitator 38. The raised profile 52 or profiled bottom may serve to prevent damage to tank 30 if agitator 38 is in motion, as well as allowing tank 30 to nest within receptacle 20 without damaging agitator 38.

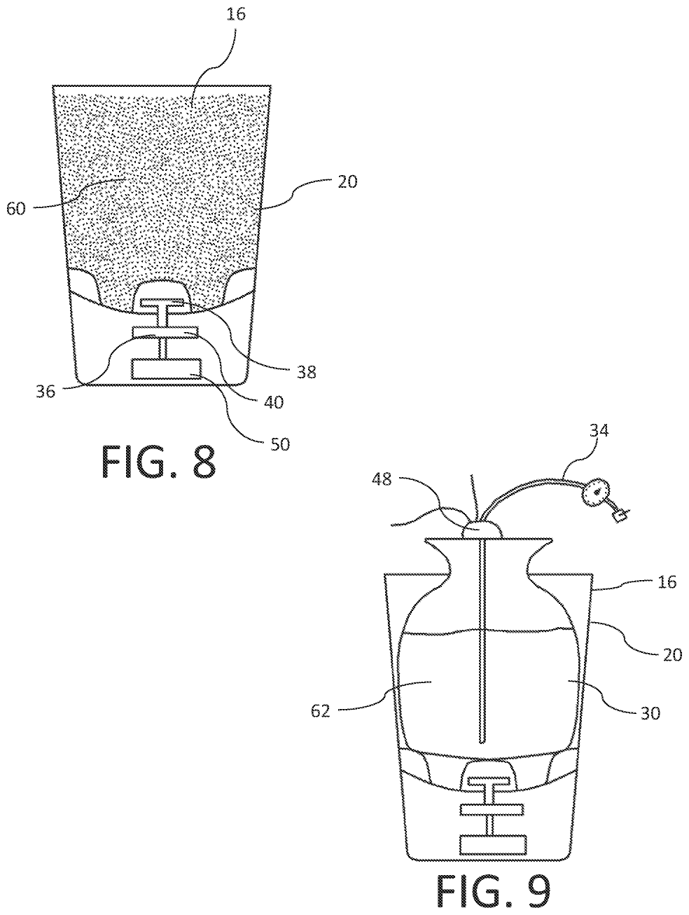

As noted previously, dispenser assembly 10 may be used to selectively dispense liquid or particulates onto ground surface 14. It is anticipated that this will be done as mower 12 is in use, such that a lawn may be treated with either liquid or granules, such as liquid or granular herbicide, pesticide, fertilizer, etc. Referring to FIG. 1, dispenser assembly 10 is attached to mower 12 such that it is positioned to distribute liquid or particulates. As shown, this may involve dispenser assembly 10 being attached to push bar 54 of mower 12, but it will be understood that other configurations may also be used. Either liquid or particulates are then selected to be dispensed onto ground surface 14. When particulates are selected, tank 30 is removed from receptacle 20 and receptacle 20 is filled with particulates 60, as shown in FIG. 8. Dispenser assembly 10 is then operated as mower 12 traverses an area to be treated area. Referring to FIG. 5, particulates 60 are directed toward the particulate outlet 26 by agitator 38 and distributed from particulate outlet 26 onto ground surface 14 using spreader 40. This may, for example, happen simultaneously with mowing, such that the particulate 60 is distributed immediately after mowing the vegetation. The volume of particulates 60 may be controlled by adjusting the area of particulate outlet 26. When liquid material is selected, tank 30 is inserted into hopper 16, which will be sufficiently free of particulates to allow access to receptacle 20, as shown in FIG. 9. Tank 30 is filled with liquid 62 as shown in FIG. 9, either before or after tank 30 is installed in receptacle 20. Fluid outlet 34 is connected to fluid passage 44 of fluid distributor 42, and fluid can then be distributed onto ground surface 14 using fluid manifold 46 by pumping the fluid through fluid passage 44 using pump 48. The connection may be automatically made when tank 30 is installed within receptacle 20, or a connection may need to be manually made to allow fluid to be supplied to manifold 46. It will also be understood that this distribution may happen simultaneously with mowing, as with particulate distribution.

It will be understood that particulate 60 may take a variety of forms, such as solid fertilizer, seed, other soil amendments, weed control herbicides, or other types of treatment. Liquid 62 may also be fertilizer or other types of treatment. While the description above is in terms of a conventional gasoline or electric powered lawn mower 12, it will be understood that the dispenser assembly may also be used with manual mowers or other lawn trimming and cutting machinery that traverse a ground surface 14. The described dispenser assembly 10 allows for selective dispensing of liquid or particulates from a single attachment to the mower 12.

In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings, but should be given the broadest interpretation consistent with the description as a whole.

What is claimed is:

1. A dispenser assembly for a mower, the dispenser selectively dispensing liquid or particulates onto a ground surface, the dispenser assembly comprising:
a hopper having an inner wall that defines a receptacle, and a particulate outlet at a bottom of the receptacle, the hopper being carried by the mower;
a tank sized to removably nest within the receptacle, the tank having a sidewall and a fluid outlet;
a particulate distributor in communication with the particulate outlet, the particulate distributor being adapted to distribute particulates through the particulate outlet onto the ground surface; and
a fluid manifold carried by the mower, the fluid manifold being releasably connectable to the fluid outlet of the tank by a fluid passage to deliver fluid from the tank to the fluid manifold.

2. The dispenser assembly of claim 1, wherein the particulate distributor comprises a motor that drives an agitator and a spreader, the agitator being disposed within the receptacle adjacent to the particulate outlet, and the spreader being disposed below the particulate outlet.

3. The dispenser assembly of claim 2, wherein a bottom of the hopper comprises a raised profile that supports the tank above the agitator.

4. The dispenser assembly of claim 2, wherein the tank has a profiled bottom surface that engages the receptacle to support the tank above the agitator.

5. The dispenser assembly of claim 1, wherein the hopper comprises a releasable attachment that is configured to attach to a push bar of the mower.

6. The dispenser assembly of claim 1, wherein the fluid manifold comprises a spreader bar.

7. The dispenser assembly of claim 6, wherein the spreader bar is attachable to a push bar of the mower such that, in operation, the spreader bar is suspended behind the mower in proximity to the ground surface.

8. The dispenser assembly of claim 1, wherein the spreader comprises an opening in the outer wall of the hopper, the opening being shaped to direct the particulates in a distribution pattern.

9. The dispenser assembly of claim 1, wherein the connection between the fluid passage and the fluid outlet of the tank comprises a quick connect fluid connection.

10. The dispenser assembly of claim 1, wherein the particulate outlet of the hopper has an adjustable area.

11. A method of selectively dispensing liquid or particulates onto a ground surface while operating a mower, the method comprising:
attaching a dispenser assembly to the mower, the dispenser assembly comprising:
a hopper having an inner wall that defines a receptacle and a particulate outlet at a bottom of the receptacle, the hopper being carried by the mower;
a tank removably nested within the receptacle, the tank having a sidewall and a fluid outlet;
a particulate distributor in communication with the particulate outlet, the particulate distributor; and
a fluid distributor carried by the mower and comprising a fluid passage that releasably connects to the fluid outlet of the tank, a fluid manifold connected to the fluid passage, and a source of pressure;
selecting liquid or particulates to be dispensed onto the ground surface;
when particulates are selected, removing the tank, filling the receptacle with the particulates, and distributing the particulates from the outlet onto the ground surface using the particulate distributor; and
when the liquid material is selected, inserting the tank into the hopper, filling the tank with liquid, connecting the fluid outlet of the tank to the fluid passage of the fluid distributor, and distributing fluid onto the ground surface by flowing the fluid through the fluid manifold via the fluid passage.

12. The method of claim 11, wherein the particulate distributor comprises a motor that drives an agitator and a spreader, the agitator being disposed within the receptacle adjacent to the particulate outlet, and the spreader being disposed below the particulate outlet.

13. The method of claim 12, wherein a bottom of the hopper comprises a raised profile that supports the tank above the agitator.

14. The method of claim 12, wherein the tank has a profiled bottom surface that engages the receptacle to support the tank above the agitator.

15. The method of claim 11, wherein the dispenser assembly is attached to a push bar of the mower.

16. The method of claim 11, wherein the fluid distributor comprises a spreader bar.

17. The method of claim 16, wherein attaching the dispenser assembly to the mower comprises attaching the spreader bar to the push bar of the mower such that the spreader bar is placed behind the mower in proximity to a ground surface.

18. The method of claim 11, wherein the spreader comprises an opening in the outer wall of the hopper, the opening being shaped to direct the particulates in a distribution pattern.

19. The method of claim 11, wherein connecting the fluid outlet of the tank to the fluid passage of the fluid distributor comprises connecting a quick connect fluid connection.

20. The method of claim 11, wherein the particulate outlet of the hopper has an adjustable area.

21. The method of claim 13, wherein the particulate distributor further comprises an agitator within the receptacle and adjacent to the particulate outlet, the agitator directing particulates toward the particulate outlet.

22. The method of claim 13, wherein the particulate distributor further comprises a spreader that distributes the particulates that pass through the particulate outlet.
